(19) United States
(12) Patent Application Publication
(10) Pub. No.: US 2015/0142522 A1
(43) Pub. Date: May 21, 2015

(54) GAMING INFORMATION PROVIDING DEVICE, GAMING INFORMATION PROVIDING SYSTEM, GAMING INFORMATION PROVIDING METHOD, PROGRAM, AND RECORDING MEDIUM

(71) Applicant: OMRON Corporation, Kyoto-shi , kyoto (JP)

(72) Inventors: Katsumi Matsushita, Kyoto (JP); Masataka Kimura, Kyoto (JP)

(21) Appl. No.: 14/379,162

(22) PCT Filed: Dec. 7, 2012
(86) PCT No.: PCT/JP2012/081835

§ 371 Date: Dec. 8, 2014

(30) Foreign Application Priority Data
Mar. 13, 2012 (JP) 2012-056371

(51) Int. Cl. G06Q 50/34; G06Q 30/06; G07F 17/32; G06Q 30/02

(52) U.S. Cl. CPC G06Q 50/34; G06Q 30/0204; G06Q 30/0631; G07F 17/3225; G07F 17/3288
USPC 705/7.33

(57) ABSTRACT

A gaming information providing device has an information acquisition unit that acquires gaming machine information, customer identification information, and preference information from a plurality of gaining machines, a storage device, and a provided information producing unit. In each of the game machines, a game medium is paid in or paid out from in a game, wherein the gaming machine information includes paying-out information indicating a paying-out status of the game medium in each of the gaming machines. The customer identification information identifies a plurality of customers who play the game with the plurality of gaming machines. The preference information indicates a preference for the game of the gaming machine in each customer.

### BACKGROUND

1. Technical Field

The present invention relates to a gaming information providing device, a gaming information providing system, a gaming information providing method, a program, and a recording medium that are used in amusement halls, such as a casino and a pachinko parlor, which include gaming machines.

2. Related Art

For example, in amusement halls such as a pachinko parlor, gaming information is provided as service for a guest, namely, a player. As to the provision of the gaming information, for example, Patent Document 1 discloses an amusement hall system including a management device connected to each pachinko gaming machine and an information public terminal connected to the management device.

Specifically, the management device acquires an out signal indicating the number of out balls, a safe signal indicating the number of safe balls, a start signal, a big win signal, and a probability variation signal, which are output from each pachinko gaming machine, and the management device individually accumulates operation data of each pachinko gaming machine. Based on the data provided from the management device, the information public terminal displays a big win history data screen, a probability variation continuation start ranking screen, an under-probability-variation-continuation big win number ranking screen, an under-probability-variation start number ranking screen, and a model-by-model probability variation continuation start number ranking screen added with a model name and machine number of the pachinko gaming machine.

Accordingly, the player can recognize a recommended pachinko gaming machine from each screen displayed on the information public terminal, and select a desired pachinko gaming machine.

The provision of the gaming information is effectively used as one of measures to increase sales because the provision of the gaming information prompts a gambling spirit of the player to lead to improvement of a repeat rate.

Patent Document 1: Japanese Unexamined Patent Publication No. 2006-158775

### SUMMARY

However, there are various types of the players (customers) depending on personality, and the players differ from one another in a way in which the player enjoys the gaming machine. Particularly, difference in player type is prominent depending on the race or a national character in the casino where peoples from different races gather together to play games.

On the other hand, in the conventional configuration, information on the recommended gaming machine reflecting the player type, namely, a customer's preference cannot be provided because the gaming information is produced only by a state of the gaming machine and opened.

One or more embodiments of the present invention provides a gaming information providing device that can provide the gaming information, which reflects the player's preference and is more favorable for the player, a gaming information providing system, a gaming information providing method, a program, and a recording medium.

According to one or more embodiments of the present invention, a gaming information providing device includes: an information acquisition unit configured to acquire gaming machine information, customer identification information, and preference information from a plurality of gaming machines each of which a game medium is paid in or paid out from in a game, the gaming machine information including paying-out information indicating a paying-out status of the game medium in each gaming machine, the customer identification information identifying a plurality of customers who play the game with the plurality of gaming machines, the preference information indicating a preference for the game of the gaming machine in each customer; a storage device in which the pieces of information acquired by the information acquisition unit are stored; an information management unit configured to classify the plurality of customers into a plurality of customer types based on the preference information while classifying the plurality of gaming machines into a plurality of gaming machine types based on the gaming machine information; and a provided information producing unit configured to produce recommended gaming machine information indicating a recommended gaming machine for each customer from the gaming machine type and the customer type.

According to one or more embodiments of the invention, the gaming information, namely, the recommended gaming machine information provided to the customer reflects not only the state of the gaming machine but also the customer's preference. Therefore, the recommended gaming machine information more favorable for the player can be provided.

### BRIEF DESCRIPTION OF THE DRAWINGS

FIG. 1 is a block diagram illustrating a configuration of a gaming information providing system according to one or more embodiments of the present invention.

FIG. 2 is a block diagram illustrating an example of a configuration of a kiosk terminal device that is of a terminal device in FIG. 1.

FIG. 3 is a block diagram illustrating an example of a configuration of a gaming machine that is of the terminal device in FIG. 1.

FIG. 4 is a perspective view illustrating an appearance of the gaming machine in FIG. 3.

FIG. 5 is a front view illustrating a customer management component in FIG. 4.

FIG. 6 is a block diagram illustrating an example of a configuration of a mobile terminal device that is of the terminal device in FIG. 1.

FIG. 7 is a perspective view illustrating an appearance of the mobile terminal device in FIG. 6.

FIG. 8 is an explanatory diagram illustrating a time-dependent gaming machine state information management table for one gaming machine managed by an information acquisition and management unit in FIG. 1.

FIG. 9 is an explanatory diagram of a gaming machine type information management table indicating a content of a gaming machine type managed by the information acquisition and management unit in FIG. 1.

FIG. 10 is an explanatory diagram illustrating a time-dependent gaming machine state information management table managed by the information acquisition and management unit in FIG. 1.

FIG. 11 is an explanatory diagram illustrating a customer-type-dependent recommended gaming machine information management table managed by the information acquisition and management unit in FIG. 1.

FIG. 12 is an explanatory diagram illustrating a customer personal information management table managed by the information acquisition and management unit in FIG. 1.

FIG. 13 is an explanatory diagram of a nationality-dependent priority display language list indicating priority order of a language to be used according to a customer's nationality with respect to gaming information provided to the terminal device from a gaming information management server in FIG. 1.

FIG. 14 is a flowchart illustrating operation to produce recommended gaming machine information that is of the gaming information in the gaming information management server in FIG. 1.

FIG. 15 is a flowchart illustrating operation to provide the recommended gaming machine information that is of the gaming information in the gaming information management server in FIG. 1.

FIG. 16 is an explanatory view illustrating the recommended gaming machine information displayed on a display device of the terminal device in FIG. 1.

FIG. 17 is an explanatory view illustrating a state in which the recommended gaming machine information in FIG. 16 is switched from English language display to Japanese language display.

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. An example in which one or more embodiments of the invention is applied to a gaming information providing system included in a casino will be described below.

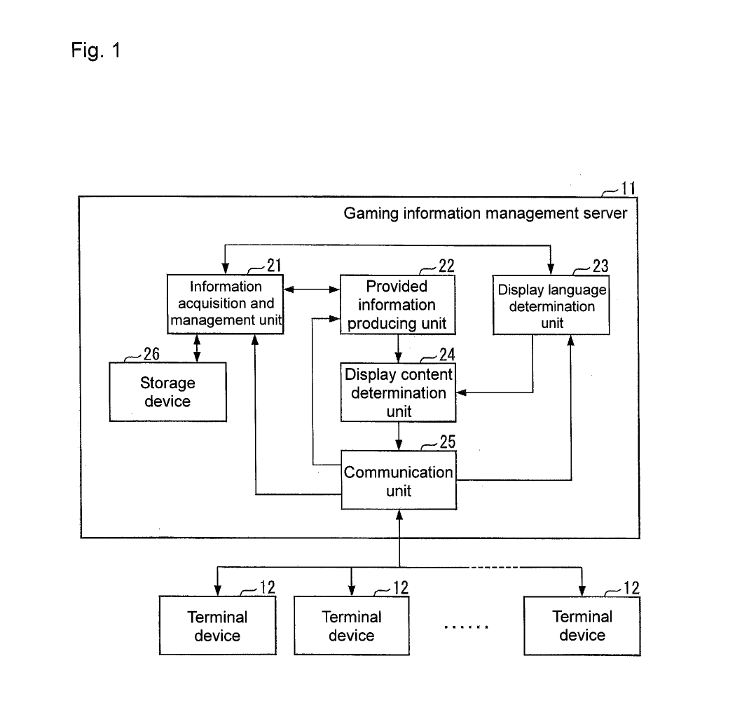

FIG. 1 is a block diagram illustrating a configuration of a gaming information providing system according to one or more embodiments of the present invention. As illustrated in FIG. 1, the gaming information providing system includes gaming information management server 11 and a plurality of terminal devices 12.

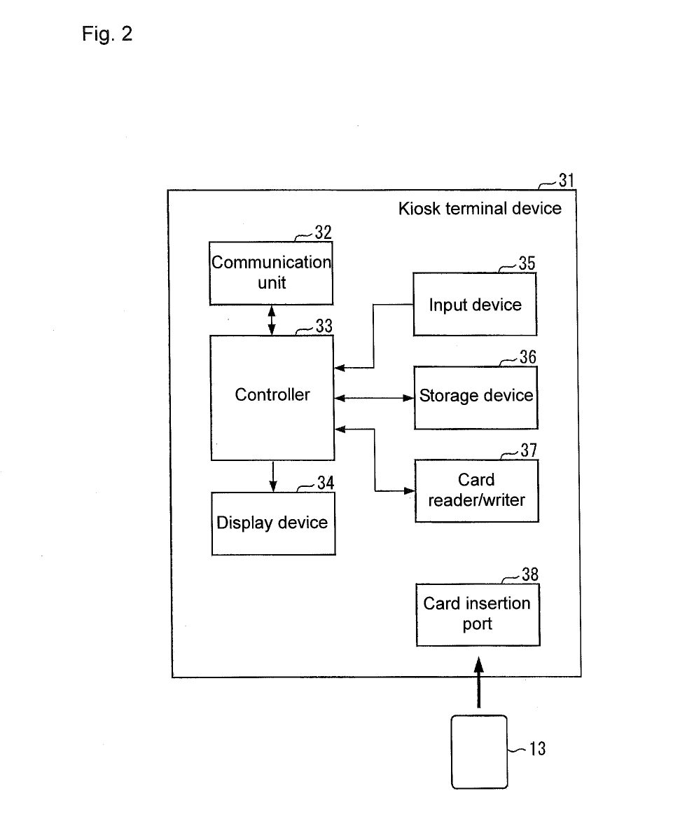

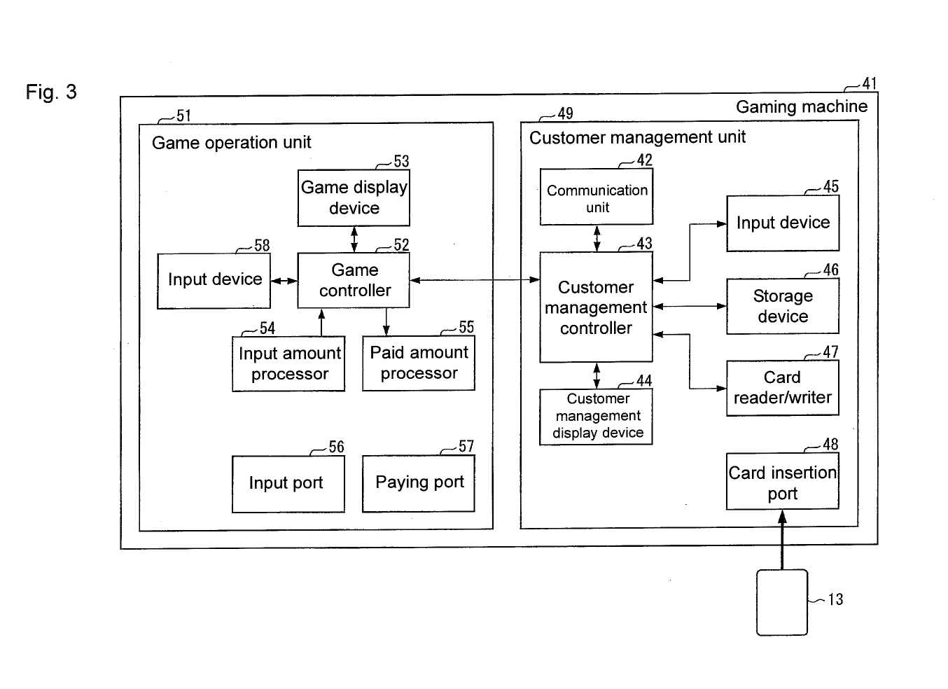

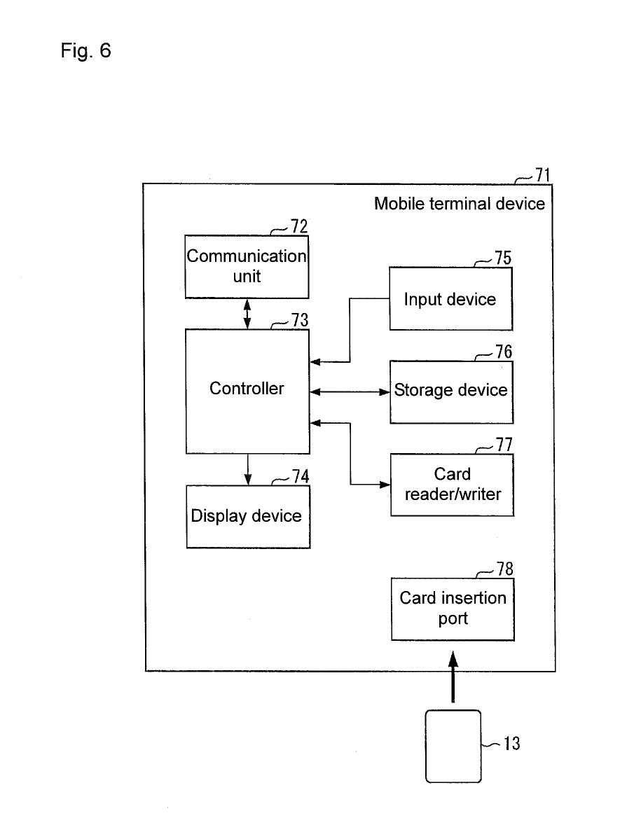

In one or more embodiments, terminal device 12 includes kiosk terminal device 31 in FIG. 2, gaming machine 41 in FIG. 3, and mobile terminal device 71 in FIG. 6. Terminal device 12 includes a display device. Terminal device 12 can read and write customer identification information while a customer card in which the customer identification information is stored is inserted in terminal device 12, terminal device 12 can conduct communication with gaming information management server 11, and terminal device 12 can display information provided from gaming information management server 11 on the display device. Terminal device 12 is provided with a computer including a CPU, a RAM, and a ROM.

Configurations of kiosk terminal device 31, gaming machine 41, and mobile terminal device 71 that are of terminal device 12 will be described below.

(Kiosk Terminal Device)

A plurality of kiosk terminal devices 31 are installed in the casino. FIG. 2 is a block diagram illustrating an example of a configuration of kiosk terminal device 31. As illustrated in FIG. 2, kiosk terminal device 31 includes communication unit 32, controller 33, display device 34, input device 35, storage device 36, and card reader/writer 37. Kiosk terminal device 31 includes card insertion port 38 in which customer card 13 is inserted.

Communication unit 32 is used when kiosk terminal device 31 transmits and receives data to and from gaming information management server 11 in a wired or wireless manner. Controller 33 controls operation of each unit in kiosk terminal device 31. For example, display device 34 is constructed with a liquid crystal display device, and displays various pieces of information under the control of controller 33. Input device 35 is used when the customer performs an input manipulation to kiosk terminal device 31. The various pieces of information are stored in storage device 36. Card reader/writer 37 reads and writes information from and in customer card 13 inserted in card insertion port 38.

For example, customer card 13 is constructed with an IC card, and provided to the customer who comes to the casino. The customer carries customer card 13 together with mobile terminal device 71 in the casino. It is not always necessary to carry mobile terminal device 71 with customer in the casino.

(Gaming Machine)

For example, gaming machine 41 is a slot machine, and many slot machines are installed in the casino. FIG. 3 is a block diagram illustrating an example of a configuration of gaming machine 41. As illustrated in FIG. 3, gaming machine 41 includes customer management unit 49, and game operation unit 51. Customer management unit 49 includes communication unit 42, customer management controller 43, customer management display device 44, input device 45, storage device 46, and card reader/writer 47. Customer management unit 49 also includes card insertion port 48 in which customer card 13 is inserted.

The configuration of gaming machine 41 is equivalent to the configuration of kiosk terminal device 31, and gaming machine 41 and kiosk terminal device 31 have similar functions. That is, communication unit 42 is equivalent to communication unit 32, customer management controller 43 is equivalent to controller 33, customer management display device 44 is equivalent to display device 34, input device 45 is equivalent to input device 35, storage device 46 is equivalent to storage device 36, card reader/writer 47 is equivalent to card reader/writer 37, and card insertion port 48 is equivalent to card insertion port 38.

Game operation unit 51 is a functional unit having an original gaming function of gaming machine 41. Game operation unit 51 includes game controller 52, game display device 53, input amount processor 54, paid amount processor 55, input port 56, paying port 57, and input device 58.

Game display device 53 includes a touch panel on a liquid crystal display device, and displays the game content under the control of game controller 52. Input amount processor 54 calculates the amount of money (game medium) input through input port 56 by the customer (player), and notifies game controller 52 of the amount of money. In the case that the customer becomes a winner in the game, paid amount processor 55 processes the amount (game medium) paid from paying port 57 under the control of game controller 52.

Input device 58 includes the touch panel of game display device 53, and is manipulated by the customer in the game of gaming machine 12. On the other hand, input device 45 of customer management unit 49 is used when the customer performs an input manipulation to gaming machine 41 (customer management unit 49).

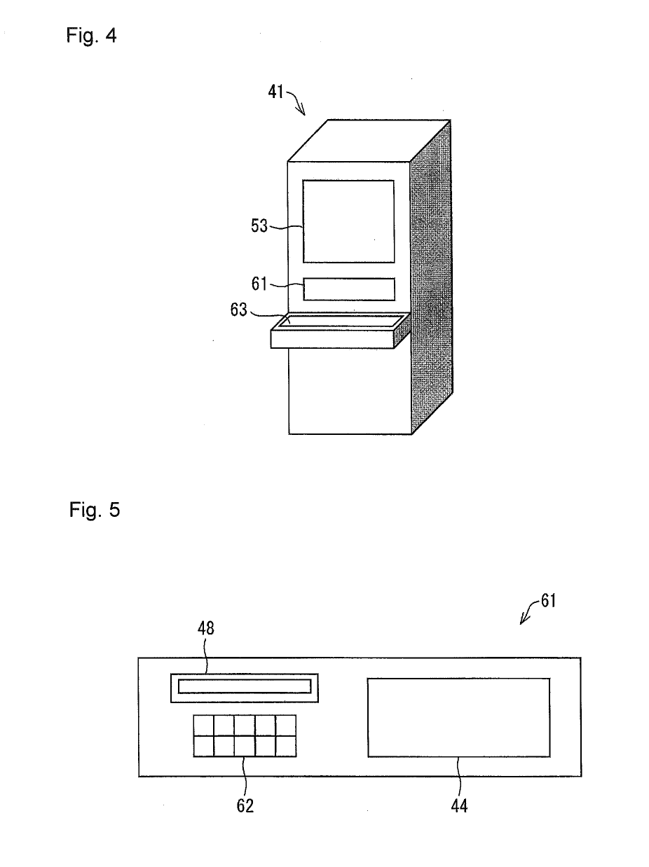

FIG. 4 is a perspective view illustrating an appearance of gaming machine 41. FIG. 5 is a front view illustrating customer management component 61 in FIG. 4. As illustrated in FIG. 4, gaming machine 41 includes game display device 53 in an upper portion of a front surface thereof and customer management component 61 below game display device 53. As illustrated in FIG. 5, customer management component 61 includes keyboard 62 in addition to customer management display device 44 and card insertion port 48. Manipulation display device 63 is provided below customer management component 61 while projected forward from the front surface of gaming machine 41. For example, manipulation display device 63 includes the touch panel on the liquid crystal display device. Keyboard 62 constitutes input device 45 of customer management unit 49 in FIG. 3, and manipulation display device 63 constitutes input device 58 of game operation unit 51.

(Mobile Terminal Device)

The customer who comes in the casino carries mobile terminal device 71 together with customer card 13. FIG. 6 is a block diagram illustrating an example of mobile terminal device 71. As illustrated in FIG. 6, mobile terminal device 71 includes communication unit 72, controller 73, display device 74, input device 75, storage device 76, and card reader/writer 77. Mobile terminal device 71 also includes card insertion port 78 in which customer card 13 is inserted and a battery (not illustrated) that is of a power supply.

The configuration of mobile terminal device 71 is equivalent to the configuration of kiosk terminal device 31, and mobile terminal device 71 and kiosk terminal device 31 have similar functions. That is, communication unit 72 is equivalent to communication unit 32, controller 73 is equivalent to controller 33, display device 74 is equivalent to display device 34, input device 75 is equivalent to input device 35, storage device 76 is equivalent to storage device 36, card reader/writer 77 is equivalent to card reader/writer 37, and card insertion port 78 is equivalent to card insertion port 38.

However, in mobile terminal device 71, communication unit 72 wirelessly conducts communication with gaming information management server 11. For example, display device 74 is constructed with an electronic paper. The electronic paper requires an electric power only in rewriting an image, and the electronic paper has a memory characteristic continuously displaying the image with no voltage application. Alternatively, display device 74 may be a well-known display device.

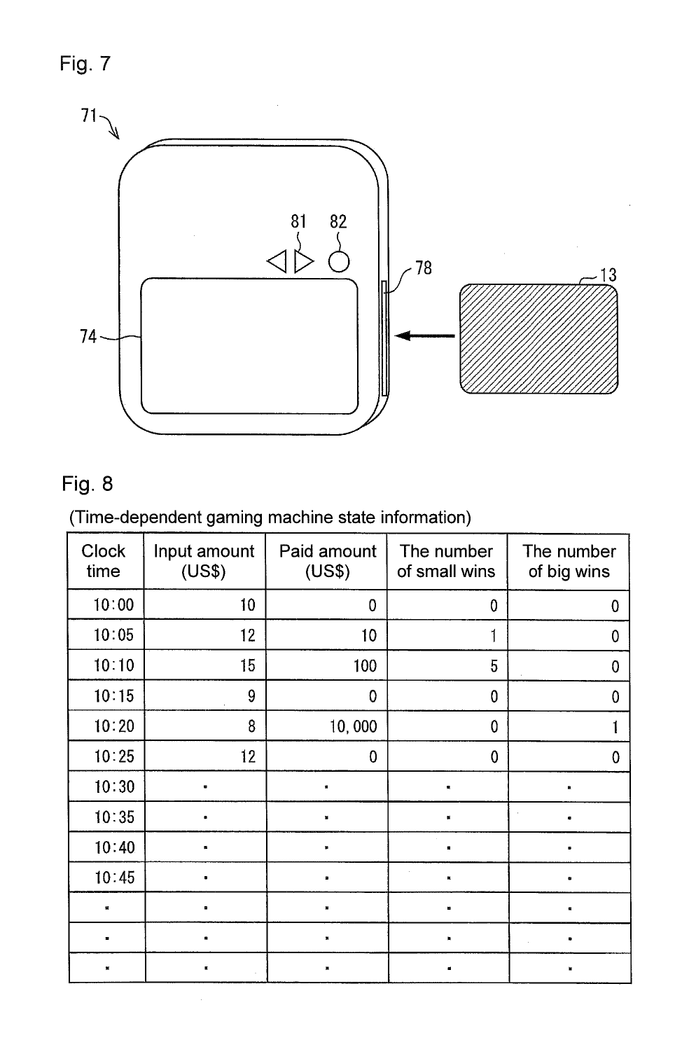

FIG. 7 is a perspective view illustrating an appearance of mobile terminal device 71. As illustrated in FIG. 7, mobile terminal device 71 includes display device 74 in a lower portion of a front surface and selection button 81 and determination button 82 above display device 74. Mobile terminal device 71 includes card insertion port 78 in a narrow side surface. Selection button 81 and determination button 82 constitute input device 75.

(Gaming Information Management Server)

Gaming information management server 11 is provided with a computer including a CPU, a RAM, and a ROM. Specifically, as illustrated in FIG. 1, gaming information management server 11 includes information acquisition and management unit (information acquisition unit and information management unit) 21, provided information producing unit 22, display language determination unit 23, display content determination unit 24, communication unit 25, and storage device 26 as each functional unit.

Communication unit 25 conducts communication with terminal device 12 connected to gaming information management server 11 in a wired or wireless manner, and transmits and receives information to and from terminal device 12.

Information acquisition and management unit 21 manages gaming machine information on gaming machine 41 and customer information on a customer. These pieces of information are stored as a management table in storage device 26. The gaming machine information includes time-dependent gaming machine state information, integrated gaming machine state information, and gaming machine type information. The customer information includes customer personal information and customer-type-dependent recommended gaming machine information.

In the gaming machine information, the time-dependent gaming machine state information indicates a state at predetermined time intervals with respect to each gaming machine 41. For example, the time-dependent gaming machine state information is managed using a time-dependent gaming machine state information management table in FIG. 8. FIG. 8 is an explanatory diagram illustrating a time-dependent gaming machine state information management table for one gaming machine 41 managed by information acquisition and management unit 21.

In the time-dependent gaming machine state information management table, the amount of money input to gaming machine 41, the amount of money paid from gaming machine 41, the number of small wins in gaming machine 41, and the number of big wins in gaming machine 41 are managed in each gaming machine 41. Pieces of original information on these management items are provided from each gaming machine 41 to gaming information management server 11. In the example in FIG. 8, each item is updated every 5 minutes.

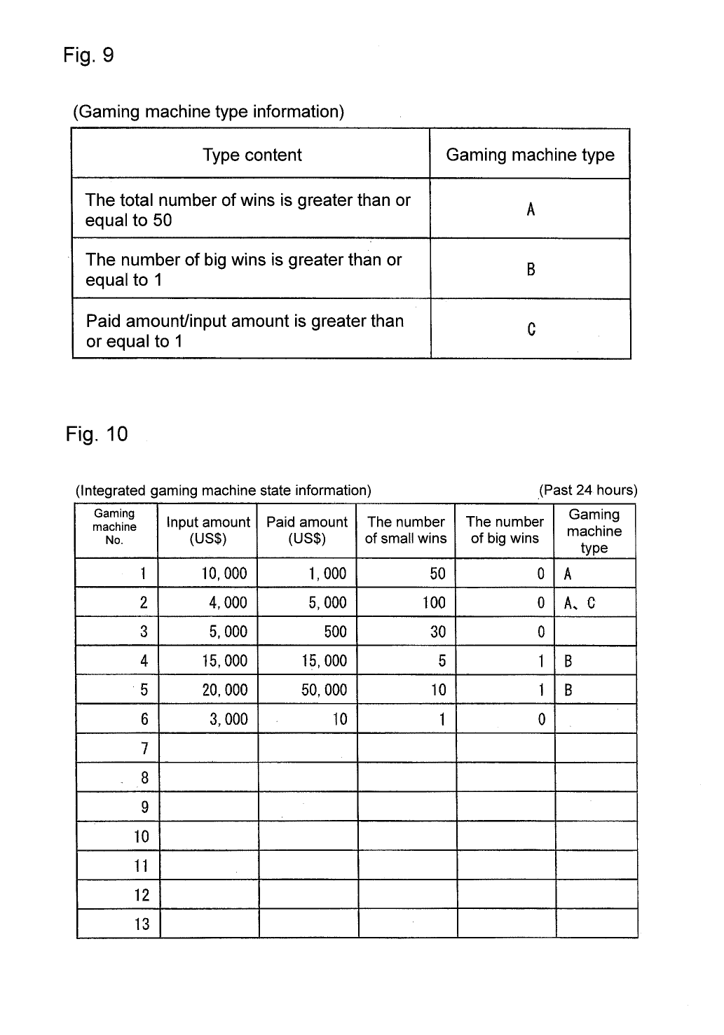

The gaming machine type information indicates speculation of each gaming machine 41 as a gaming machine type. For example, the gaming machine type information is managed using a gaming machine type information management table in FIG. 9. FIG. 9 is an explanatory diagram of the gaming machine type information management table illustrating a content of the gaming machine type managed by information acquisition and management unit 21. In the example in FIG. 9, gaming machine 41 in which the total number of wins including the number of small wins and the number of big wins is larger than or equal to 50 in the past 24 hours is set to gaming machine type A, gaming machine 41 in which the number of big wins is larger than or equal to 1 in the past 24 hours is set to gaming machine type B, and gaming machine 41 in which a ratio of the paid amount to the input amount is larger than or equal to 1 in the past 24 hours is set to gaming machine type C.

The integrated gaming machine state information indicates state information on gaming machine 41 obtained from the time-dependent gaming machine state information in the past 24 hours and a type (gaming machine type) of each gaming machine 41 that is set by referring to the gaming machine type information in FIG. 9 based on the state information. For example, the integrated gaming machine state information is managed using an integrated gaming machine state information management table in FIG. 10. FIG. 10 is an explanatory diagram illustrating a time-dependent gaming machine state information management table managed by information acquisition and management unit 21. In the example in FIG. 10, the input amount, the paid amount, the number of small wins, the number of big wins, and the gaming machine type of each gaming machine 41 in the past 24 hours are indicated as the integrated gaming machine state information.

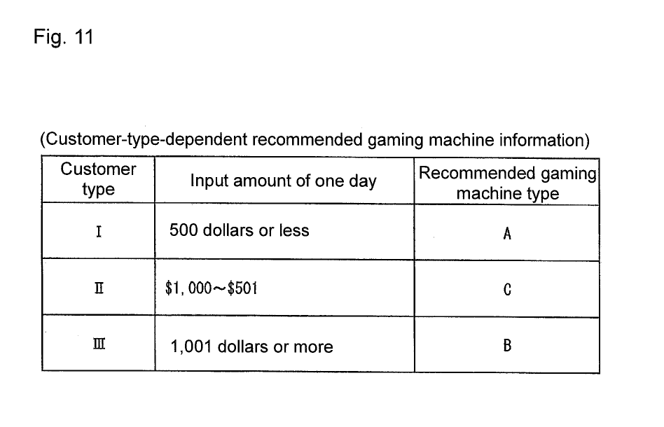

In the customer information, the customer-type-dependent recommended gaming machine information indicates gaming machine 41 (recommended gaming machine 41) to be recommended to the customer based on the amount input to gaming machine 41 by the customer in one day. For example, the customer-type-dependent recommended gaming machine information is managed using a customer-type-dependent recommended gaming machine information management table in FIG. 11. FIG. 11 is an explanatory diagram illustrating the customer-type-dependent recommended gaming machine information management table managed by information acquisition and management unit 21.

In the example in FIG. 11, a recommended gaming machine type is set to gaming machine type A for the customer (customer type I) who inputs the amount of 500 dollars or less to gaming machine 41 in one day, the recommended gaming machine type is set to gaming machine type B for the customer (customer type II) who inputs the amount of 501 to 1,000 dollars to gaming machine 41 in one day, and the recommended gaming machine type is set to gaming machine type C for the customer (customer type III) who inputs the amount of 1,001 dollars or more to gaming machine 41 in one day.

The information indicating the input amount of the customer in one day is provided from each gaming machine 41 used by the customer to gaming information management server 11. That is, in the case that the customer uses gaming machine 41, customer card 13 is inserted in card insertion port 48 of gaming machine 41. In gaming machine 41, customer card 13 is read, and customer personal information recorded in customer card 13 is transmitted to gaming information management server 11. While customer card 13 is inserted in card insertion port 48, gaming machine 41 transmits the information on the amount input to gaming machine 41 by the customer and the information on the amount paid from gaming machine 41 to gaming information management server 11 at predetermined time intervals. Information acquisition and management unit 21 of gaming information management server 11 produces the information indicating the input amount of the customer in one day based on the information provided from gaming machine 41.

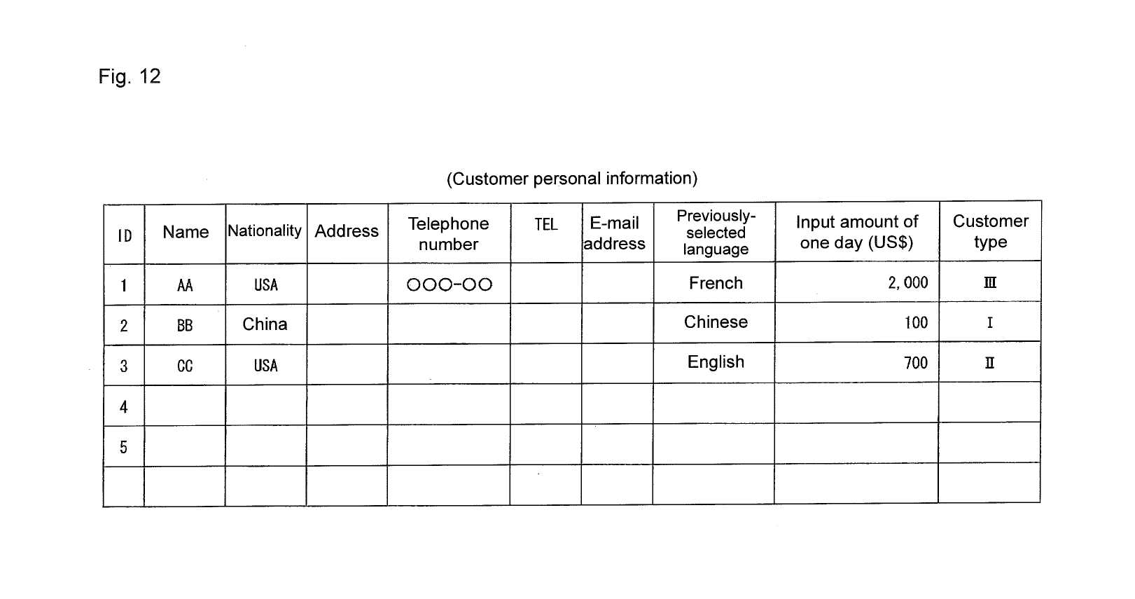

As illustrated in FIG. 12, the customer personal information indicates personal information on each customer. FIG. 12 is an explanatory diagram illustrating a customer personal information management table managed by information acquisition and management unit 21. In the example in FIG. 12, the customer personal information includes pieces of basic information such as a name, a nationality, an address, and a telephone number (and an e-mail address) of the customer. The customer personal information also includes information on the language (previously-selected language) previously selected as display language information by the customer. Additionally, the customer personal information includes information indicating the amount input to gaming machine 41 by the customer in one day and, based on the information, information indicating a customer type that is set to the customer by referring to the customer-type-dependent recommended gaming machine information in FIG. 11.

In the case that the recommended gaming machine information that is of the gaming information is provided to terminal device 12, provided information producing unit 22 acquires the recommended gaming machine information on the customer indicated by the customer identification information from information acquisition and management unit 21, and transmits the recommended gaming machine information on the customer to display content determination unit 24. The recommended gaming machine information indicates gaming machine 12 to be recommended to the customer.

Display language determination unit 23 checks the customer's nationality indicated by the customer identification information, determines the display language of the recommended gaming machine information according to the customer's nationality, and notifies display content determination unit 24 of the determined display language. In the case that the previously-selected language is registered in customer personal information in FIG. 12, display language determination unit 23 notifies display content determination unit 24 of the previously-selected language together with the nationality.

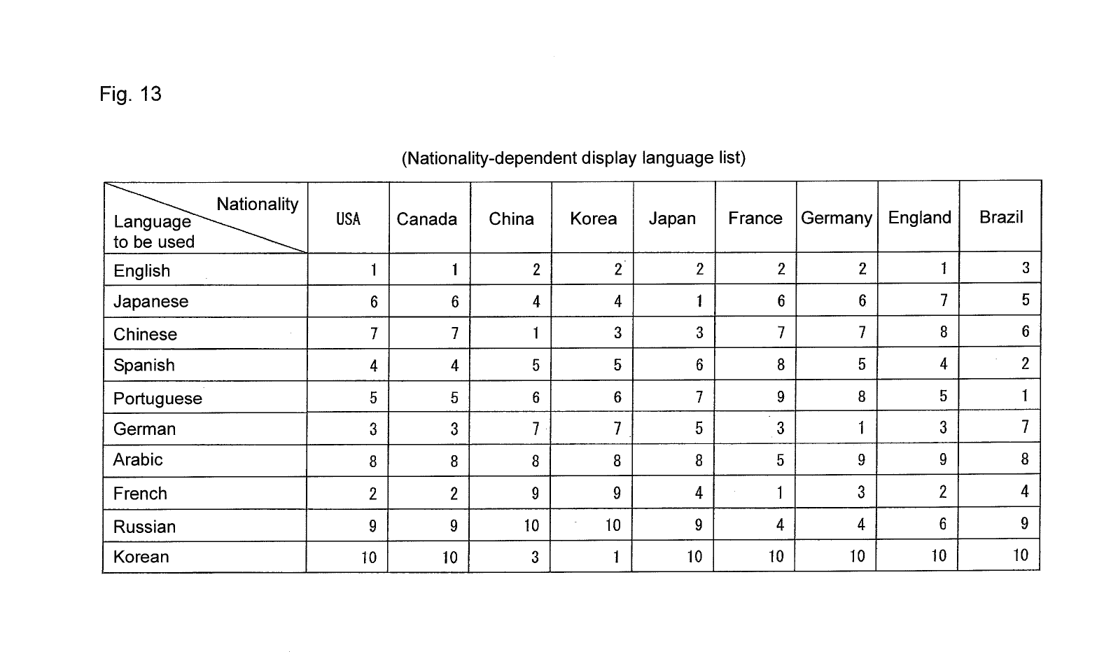

Display content determination unit 24 refers to the nationality-dependent priority display language list in FIG. 13 to put display recommended gaming machine information into a state in which the display recommended gaming machine information is translated in each language indicated in the list as the language to be used according to the nationality. In this case, display content determination unit 24 arranges the pieces of recommended gaming machine information in the languages in priority order set in the list. When the previously-selected language exists, display content determination unit 24 rearranges the pieces of display recommended gaming machine information in the languages such that the display recommended gaming machine information in the previously-selected language is located at a top priority (located in a front row).

The nationality-dependent priority display language list is used by display content determination unit 24, and indicates the priority order of the languages to be used according to the customer's nationalities as illustrated in FIG. 13. The priority order is indicated by a numerical number. The nationality-dependent priority display language list is stored in storage device 26.

FIG. 13 is an explanatory diagram of the nationality-dependent priority display language list indicating the priority order of the languages to be used according to the customer's nationalities with respect to the gaming information provided from gaming information management server 11 to terminal device 12. In the example of the nationality-dependent priority display language list in FIG. 10, in the case that the customer's nationality is USA, the priority order of the language to be used is English, French, German, Spanish, Portuguese, Japanese, Chinese, Arabic, Russian, and Korean.

In the above configuration, operation of the gaming information providing system of one or more embodiments will be described below.

(Registration of Basic Information in Customer Personal Information)

Operation to register the customer personal information will be described. The customer carries mobile terminal device 71 and customer card 13 in the casino. Customer card 13 is issued at a manned reception counter. In this case, at the reception counter, the customer personal information is registered in customer card 13 by inputting the customer personal information to a terminal device based on a passport, a driver's license or the like that identifies the person. In this case, the basic information in the customer personal information, namely, name, nationality, address, telephone number and the like are registered.

The basic information input from the terminal device at the reception counter is transmitted from the terminal device to gaming information management server 11. In gaming information management server 11, communication unit 25 receives the basic information and transmits the basic information to information acquisition and management unit 21. When acquiring the customer basic information, information acquisition and management unit 21 registers the customer basic information in the customer personal information management table.

The basic information in the customer personal information registered in the customer personal information management table is not limited to the above items, but any item may be used as the basic information as long as the item can identify the customer and recognize the customer's nationality. The basic information recorded in customer card 13 may be the information (customer identification information) that can identify the customer.

(Production of Gaming Information)

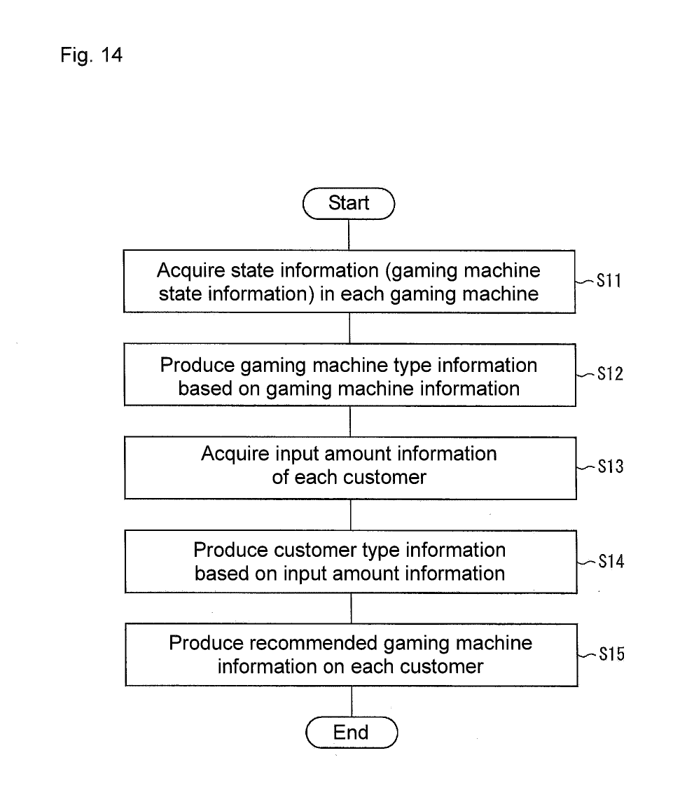

The gaming information producing operation will be described below. In the gaming information producing operation, the recommended gaming machine information reflecting a customer's preference is produced as the gaming information in each customer. FIG. 14 is a flowchart illustrating the recommended gaming machine information producing operation as the gaming information in gaming information management server 11.

In producing the recommended gaming machine information, information acquisition and management unit 21 of gaming information management server 11 acquires the gaming machine state information (gaming machine information) on each gaming machine 41 (S11). The gaming machine state information indicates a gaming machine state such as the input amount, the paid amount, the number of small wins, and the number of big wins in a predetermined time period (for example, past 24 hours) of each gaming machine 1.

Then information acquisition and management unit 21 produces the gaming machine type information based on the acquired gaming machine state information (S12). The gaming machine type information indicates the type of each gaming machine 1 classified by gambling such as the total number of wins including the small win and the big win, the existence or non-existence of the big win, and the rate of the paid amount to the input amount of gaming machine 1.

Information acquisition and management unit 21 acquire the input amount information in each customer (S13). The input amount information indicates the amount input to gaming machine 1 by each customer in a predetermined time period (for example, one day). The input amount information is preference information indicating the preference of each customer for the game of gaming machine 1.

Then information acquisition and management unit 21 produces the customer type information based on the input amount information on each customer (S14). The customer type information indicates the type of each customer classified by a degree of preference of the customer for the gamble.

Information acquisition and management unit 21 produces the recommended gaming machine information on each customer from the gaming machine type information and the customer type information (S15). The recommended gaming machine information on each customer indicates recommended gaming machine 1 to the customer according to the customer's preference.

The gaming machine information producing operation performed by information acquisition and management unit 21 will be described in detail below.

When the customer plays the game with one of gaming machines 41, the customer starts the game after inserting customer card 13 in card insertion port 48 of gaming machine 41. When that the customer ends the game, the customer pulls customer card 13 out of card insertion port 48.

When customer card 13 is inserted in card insertion port 48, the customer identification information recorded in customer card 13 is read by card reader/writer 47 and transmitted to gaming information management server 11. Therefore, gaming information management server 11 can identify the customer who plays the game with gaming machine 41.

There is no limitation to the configuration identifying the customer who plays the game with gaming machine 41. For example, the customer may manually input the identification information (for example, a customer ID number) from input device 45 of gaming machine 41 with no use of customer card 13, and the identification information may be transmitted to gaming information management server 11.

When the customer plays the game while customer card 13 is inserted in card insertion port 48 of gaming machine 41, the amount input to input port 56 in the game is checked by input amount processor 54, and output to game controller 52 as information on the amount input by the customer indicated by the customer identification information. At predetermined time intervals or in each game, game controller 52 notifies customer management controller 43 of the input amount information on each customer, and communication unit 42 transmits the input amount information on each customer to gaming information management server 11.

When the customer plays the game while customer card 13 is inserted in card insertion port 48 of gaming machine 41, the amount paid from paying port 57 in the game is processed by paid amount processor 55 under the control of game controller 52. In this case, game controller 52 notifies customer management controller 43 of the paid amount information on each customer indicated by the customer identification information at predetermined time intervals or in each game, and communication unit 42 transmits the paid amount information on each customer to gaming information management server 11.

In each gaming machine 41, irrespective of the existence or non-existence of the customer identification information (irrespective of the existence or non-existence of customer card 13), the information (input amount information on each gaming machine 41) on the amount input to input port 56, the information (paid amount information on each gaming machine 41) on the amount paid through paying port 57, the information on the number of small wins, and the information on the number of big wins are output from communication unit 42 to gaming information management server 11 at predetermined time intervals or in each game.

In gaming information management server 11, when communication unit 25 receives the input amount information on each customer, the paid amount information on each customer, the input amount information on each gaming machine 41, the paid amount information on each gaming machine 41, the information on the number of small wins, and the information on the number of big wins, these pieces of information are transmitted to information acquisition and management unit 21. When receiving the pieces of information, information acquisition and management unit 21 stores the pieces of information in storage device 26.

Then information acquisition and management unit 21 reads the pieces of information from storage device 26 to produce the management tables.

With respect to the time-dependent gaming machine state information management table in FIG. 8, information acquisition and management unit 21 produces the pieces of information on the input amount, the paid amount, the number of small wins, and the number of big wins from the input amount information, the paid amount information, the information on the number of small wins, and the information on the number of big wins of each gaming machine 41.

With respect to the integrated gaming machine state information management table in FIG. 10, information acquisition and management unit 21 produces the pieces of information on the input amount, the paid amount, the number of small wins, and the number of big wins of each gaming machine 41 from the input amount information, the paid amount information, the information on the number of small wins, and the information on the number of big wins of each gaming machine 41 in the past 24 hours.

With respect to the integrated gaming machine state information management table in FIG. 10, information acquisition and management unit 21 produces the item of the gaming machine type by referring to the gaming machine type information management table in FIG. 9. Specifically, gaming machine 1 in which the total number of wins is greater than or equal to 50 is extracted from the information on the number of small wins and the information on the number of big wins of each gaming machine 41 in one day (past 24 hours), and set to gaming machine type A. Gaming machine 1 in which the number of big wins is greater than or equal to 1 is extracted from the information on the number of big wins of each gaming machine 41 in one day, and set to gaming machine type B. (Paid amount/input amount) is calculated from the input amount information and the paid amount information of each gaming machine 41 in one day, and gaming machine 1 in which (paid amount/input amount) is greater than or equal to 1 is extracted, and set to gaming machine type C.

As described earlier, based on the personal information input in kiosk terminal device 31, information acquisition and management unit 21 produces the basic information (name, nationality, address, and telephone number) in the customer personal information with respect to the customer personal information management table in FIG. 12. The input amount in one day is produced by obtaining the input amount in one day from the input amount information on each customer.

The customer type is obtained from the input amount in one day by referring to the customer-type-dependent recommended gaming machine information management table in FIG. 11. Specifically, the customer whose amount input to gaming machine 41 is less than or equal to 500 dollars in one day is set to customer type I (recommended gaming machine type A), the customer whose amount input to gaming machine 41 ranges from 501 to 1,000 dollars in one day is set to customer type II (recommended gaming machine type B), the customer whose amount input to gaming machine 41 is greater than or equal to 1,001 dollars in one day is set to customer type III (recommended gaming machine type C).

(Provision of Gaming Information)

The operation to provide the recommended gaming machine information that is of the gaming information to terminal device 12 from gaming information management server 11 will be described below.

Gaming information management server 11 provides each customer with the produced recommended gaming machine information on each customer. As a first case, the recommended gaming machine information providing operation is performed upon a request from terminal device 12 manipulated by the customer. As a second case, the recommended gaming machine information providing operation is performed based on some sort of a manipulation by the customer with terminal device 12.

For the first case, for example, input devices 35 and 45 are manipulated in kiosk terminal device 31 or gaming machine 41 to make a request to provide the recommended gaming machine information. For the second case, for example, in mobile terminal device 71, customer card 13 is inserted in card insertion port 78.

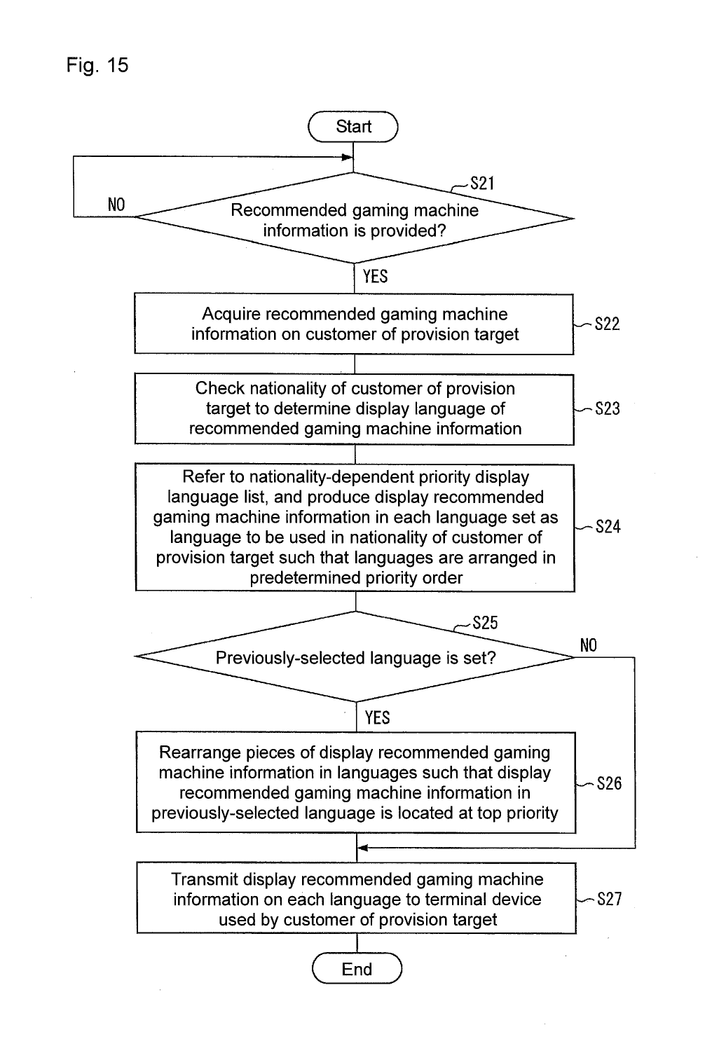

FIG. 15 is a flowchart illustrating the operation to provide the recommended gaming machine information that is of the gaming information in gaming information management server 11. The first and second cases will be described below.

In the case that gaming information management server 11 provides the recommended gaming machine information to terminal device 12, customer card 13 is inserted in kiosk terminal device 31, gaming machine 41, or mobile terminal device 71 that is of terminal device 12, and the customer identification information of customer card 13 is transmitted from terminal device 12 to gaming information management server 11. Accordingly, gaming information management server 11 can specify the customer, namely, terminal device 12 to which the recommended gaming machine information should be provided.

When the recommended gaming machine information is provided (S21), provided information producing unit 22 of gaming information management server 11 checks the customer identification information of customer card 13, which is received through communication unit 25, and acquires the recommended gaming machine information on the customer indicated by the customer identification information from information acquisition management unit 21 (S22). Provided information producing unit 22 transmits the acquired recommended gaming machine information to display content determination unit 24.

Display language determination unit 23 checks the customer's nationality indicated by the customer identification information, determines the display language of the recommended gaming machine information, and notifies display content determination unit 24 of the determined display language (S23). In the case that the previously-selected language is registered in the customer personal information in FIG. 12, display language determination unit 23 also notifies display content determination unit 24 of the information indicating the previously-selected language.

Display content determination unit 24 refers to the nationality-dependent priority display language list in FIG. 13 to produce display recommended gaming machine information in each language indicated in the list as the language to be used according to the nationality. In this case, display content determination unit 24 arranges the pieces of recommended gaming machine information in the languages in the priority order set in the list (S24).

When the previously-selected language is set (S25), display content determination unit 24 rearranges the pieces of display recommended gaming machine information in the languages such that the previously-selected language is located at the top priority (located in the front row) (S26).

Then communication unit 25 transmits the display recommended gaming machine information on each language, which is produced by display content determination unit 24, to terminal device 12 of provision target (S27).

When receiving the recommended gaming machine information from gaming information management server 11, terminal device 12 causes the display device to display the recommended gaming machine information. That is, in the case that terminal device 12 is kiosk terminal device 31, controller 33 of kiosk terminal device 31 causes display device 34 to display the recommended gaming machine information received by communication unit 32. In the case that terminal device 12 is gaming machine 41, customer management controller 43 of gaming machine 41 causes customer management display device 44 to display the recommended gaming machine information received by communication unit 42. In the case that terminal device 12 is mobile terminal device 71, controller 73 of mobile terminal device 71 causes display device 74 to display the recommended gaming machine information received by communication unit 72.

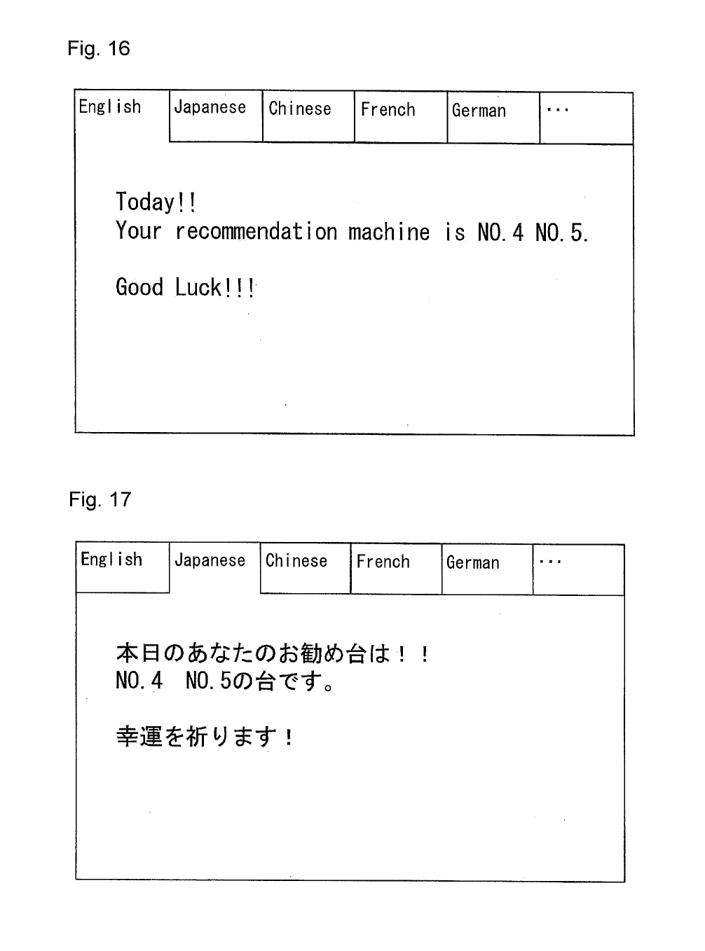

FIG. 16 is an explanatory view illustrating the recommended gaming machine information displayed on the display device of terminal device 12. In the example in FIG. 16, the recommended gaming machine information shows that the gaming machines having the numbers 4 and 5 are recommended to the customer. In the recommended gaming machine information in FIG. 16, the customer's nationality is Japan, and the previously-selected language is English. Accordingly, in FIG. 16, English is displayed as the first priority although Japanese has the first priority in the priority order of the language to be used in the case that the nationality is Japan in the nationality-dependent priority display language list in FIG. 13.

In terminal device 12, the display language of the recommended gaming machine information can be switched while the recommended gaming machine information is displayed on the display device. In this case, the customer manipulates the input device (input device 35, input device 45, or input device 75) to select the language to be used (display language), thereby switching the display language. For the touch panel-type display device (display device 34, customer management display device 44, or display device 74) of terminal device 12, the customer touches a tab of the language to be used (display language) in the displayed recommended gaming machine information, thereby switching the display language.

FIG. 17 is an explanatory view illustrating a state in which the recommended gaming machine information in FIG. 16 is switched from English language display to Japanese language display.

In addition to the first and second cases, the recommended gaming machine information may be provided from gaming information management server 11 to terminal device 12 at predetermined time intervals or at timing the recommended gaming machine information on each customer changes.

In the case that the recommended gaming machine information is provided to terminal device 12 at predetermined time intervals, after first provision of a day of the recommended gaming machine information to terminal device 12 that is used by the customer, the recommended gaming machine information may be provided to terminal device 12 used by the same customer at predetermined time intervals, for example, every one hour.

The recommended gaming machine information on each customer changes in the case that at least one of the gaming machine type and the customer type changes. In the case that at least one of the gaming machine type and the customer type changes, the operation to produce the recommended gaming machine information on each customer and the operation to provide the recommended gaming machine information to terminal device 12 are similar to those described above.

As described above, for example, gaming information management server 11 classifies gaming machines 41 into a plurality of gaming machine types by the total number of wins including the small win and the big win, the number of big wins, and the rate of the paid amount to the input amount of gaming machine 41 in the past 24 hours. For example, gaming information management server 11 classifies the customers into a plurality of customer types by the amount input to gaming machine 41 by the customer in one day (or past 24 hours). The recommended gaming machine information indicating gaming machine 41 of a type corresponding to the customer type is produced by a combination of each customer type and each gaming machine type, and provided to the customer (terminal device 12 used by the customer). Accordingly, the gaming information reflecting the customer's preference can be provided.

The recommended gaming machine information provided from gaming information management server 11 to terminal device 12 used by the customer is translated into the language corresponding to the customer's nationality, and translated into the plurality of languages corresponding to the nationalities indicated in the nationality-dependent priority display language list. Accordingly, even if the casino provided with the gaming information providing system including gaming information management server 11 is a foreign casino, the customer (player) does not bear the burden of language understanding in the casino, but the customer can easily use the recommended gaming machine information to enjoy the game. A utilization ratio of gaming machine 41 can be improved in the casino.

(Program and Recording Medium for Gaming Information Management Server)

Each block of gaming information management server 11, particularly information acquisition management unit 21, provided information producing unit 22, display language determination unit 23, and display content determination unit 24 may be constructed with hardware logic or software using a CPU (Central Processing Unit).

That is, gaming information management server 11 includes the CPU that executes a command of a control program implementing each function, a ROM (Read Only Memory) in which the program is stored, a RAM (Random Access Memory) on which the program is expanded, and a storage device (recording medium), such as a memory, in which the program and various pieces of data are stored. The recording medium in which a program code (executable format program, intermediate code program, and source program) of the control program for gaming information management server 11 that is of the software implementing each function is recorded in a computer-readable manner is supplied to the gaming information management server 11, and a computer (or CPU or MPU) reads and executes the program code recorded in the recording medium.

Examples of the recording medium include tape systems such as a magnetic tape and a cassette tape, disk systems including magnetic disks such as a floppy (registered trademark) disk and a hard disk and optical disks such as a CD-ROM, an MO, an MD, a DVD, and a CD-R, card systems such as an IC card (including a memory card) and an optical card, and semiconductor memory systems such as a mask ROM, an EPROM, an EEPROM (registered trademark), and a flash ROM.

The gaming information management server 11 may be connectable to a communication network, and the program code may be supplied through the communication network. There is no particular limitation to the communication network. For example, the Internet, an intra-net, an extra-net, a LAN, an ISDN, a VAN, a CATV communication network, a virtual private network, a telephone line network, a mobile communication network, and a satellite communication network can be used as the communication network. There is no particular limitation to a transmission medium constituting the communication network. For example, both a wired transmission medium such as IEEE1394, a USB, a power-line carrier, a cable TV line, a telephone line, and an ADSL line and a wireless transmission medium such as an infrared ray including IrDA and a remote controller, Bluetooth (registered trademark), 802.11 wireless, HDR, a mobile phone network, a satellite line, and a digital terrestrial broadcasting network can be used as the transmission medium. Additionally, one or more embodiments of the invention can be implemented in the form of a carrier-embedded computer data signal in which the program code is embodied by electronic transmission.

As described above, the gaming information providing device of one or more embodiments of the invention includes: an information acquisition unit configured to acquire gaming machine information, customer identification information, and preference information from a plurality of gaming machines each of which a game medium is paid in or paid out from in a game, the gaming machine information including paying-out information indicating a paying-out status of the game medium in each gaming machine, the customer identification information identifying a plurality of customers who play the game with the plurality of gaming machines, the preference information indicating a preference for the game of the gaming machine in each customer; a storage device in which the pieces of information acquired by the information acquisition unit are stored; an information management unit configured to classify the plurality of customers into a plurality of customer types based on the preference information while classifying the plurality of gaming machines into a plurality of gaming machine types based on the gaming machine information; and a provided information producing unit configured to produce recommended gaming machine information indicating a recommended gaming machine for each customer from the gaming machine type and the customer type.

A gaming information providing method of one or more embodiments of the invention includes: an information acquisition step of acquiring gaming machine information, customer identification information, and preference information from a plurality of gaming machines each of which a game medium is paid in or paid out from in a game, the gaming machine information including paying-out information indicating a paying-out status of the game medium in each gaming machine, the customer identification information identifying a plurality of customers who play the game with the plurality of gaming machines, the preference information indicating a preference for the game of the gaming machine in each customer; a storage step of storing the pieces of information acquired in the information acquisition step; an information management step of classifying the plurality of customers into a plurality of customer types based on the preference information while classifying the plurality of gaming machines into a plurality of gaming machine types based on the gaming machine information; and a provided information producing step of producing recommended gaming machine information indicating a recommended gaming machine for each customer from the gaming machine type and the customer type.

According to the above configuration, in the gaming machine, the game medium can be paid in and paid out during the game. For example, the game medium is a game ball in a pachinko machine and a coin in a casino. In the casino, sometimes the game medium is paid in on credit.

The information acquisition unit (in the information acquisition step) acquires the gaming machine information including the paying-out information indicating the paying-out status of the game medium in each gaming machine, the customer identification information identifying the plurality of customers who play the games with the gaming machines, and the preference information indicating the preference of each customer for the game of the gaming machine from the plurality of gaming machines. The pieces of information acquired by the information acquisition unit (in the information acquisition step) are stored in the storage device (in the storage step). The information management unit (in the information management step) classifies the plurality of gaming machines into the plurality of gaming machine types based on the gaming machine information. The information management unit also classifies the plurality of customers into a plurality of customer types based on the preference information. The provided information producing unit (in the provided information producing step) produces the recommended gaming machine information indicating the recommended gaming machine for each customer from the gaming machine type and the customer type.

Accordingly, the recommended gaming machine information reflects not only the state of the gaming machine but also the customer's preference. Therefore, the recommended gaming machine information more favorable for the customer, namely, player can be provided.

In the gaming information providing device, the preference information may be paying-in information indicating a paying-in status of the game medium for the gaming machine in each customer.

According to the above configuration, because the preference information on the customer is the paying-in information indicating the paying-in status of the game medium for the gaming machine in each customer, the recommended gaming machine information produced with the paying-in information as the preference information on the customer can properly reflect the present preference of the customer.

The gaming information providing device may further include a display language determination unit and a display content determination unit. In the gaming information providing device, the information management unit may manage nationality information on the customer as customer individual information, the display language determination unit may determine a display language of the recommended gaming machine information based on a customer's nationality indicated by the nationality information, and the display content determination unit may put the recommended gaming machine information into a state in which the recommended gaming machine information is translated into the display language determined by the display language determination unit.

According to the above configuration, the display language determination unit determines the display language of the recommended gaming machine information based on the customer's nationality indicated by the nationality information, and the display content determination unit puts the recommended gaming machine information into the state in which the recommended gaming machine information is translated into the display language determined by the display language determination unit. Accordingly, the recommended gaming machine information can be provided in the display language corresponding to the customer's nationality even in the amusement hall such as the casino where the customers from different nationalities gather together to play games.

In the gaming information providing device, the display language determination unit may have a nationality-dependent display language list indicating the display language in plural set based on the customer's nationality, and the display content determination unit may put the recommended gaming machine information into a state in which the recommended gaming machine information is translated into the plurality of display languages indicated by the nationality-dependent display language list.

According to the above configuration, the recommended gaming machine information is put into the state in which the recommended gaming machine information is translated into the plurality of display languages indicated by the nationality-dependent display language list. Accordingly, the customer who uses the recommended gaming machine information can cause the terminal device to display the recommended gaming machine information by selecting a desired language from the plurality of display languages indicated by the nationality-dependent display language list. Therefore, for example, a customer who is better at a language different from a language corresponding to the nationality can use the recommended gaming machine information in the desired language in the terminal device.

In the gaming information providing device, the nationality-dependent display language list may be a nationality-dependent priority display language list that indicates priority order of the plurality of display languages set based on the customer's nationality, the priority order indicating that a language corresponding to the nationality has a top priority, and the display content determination unit may put pieces of the recommended gaming machine information translated into the plurality of display languages into a state in which the pieces of recommended gaming machine information are arranged in a priority order indicated by the nationality-dependent priority display language list.

According to the above configuration, the pieces of recommended gaming machine information translated into the plurality of display languages are arranged in the priority order indicated by the nationality-dependent priority display language list. Accordingly, user-friendliness can further be enhanced in the case that the customer uses the recommended gaming machine information in the language different from the language corresponding to the nationality.

In the gaming information providing device, the information acquisition unit may acquire information indicating a previously-selected language, the previously-selected language being previously selected as the display language of the recommended gaming machine information by a terminal device that provides the recommended gaming machine information, the information indicating the previously-selected language may be stored in the storage device, and the display content determination unit may arrange the recommended gaming machine information in the previously-selected language at a top priority of the priority order when the previously-selected language is stored in the storage device.

According to the above configuration, the recommended gaming machine information in the previously-selected language is arranged at the top priority of the priority order when the information indicating the previously-selected language that is previously selected as the display language of the recommended gaming machine information in the terminal device providing the recommended gaming machine information. Accordingly, the user-friendliness can further be enhanced in the case that the customer uses the recommended gaming machine information.

A gaming information providing system of one or more embodiments of the invention includes: the above-mentioned gaming information providing device; and a terminal device including a display device, the terminal device configured to transmit and receive information to and from the gaming information providing device in a wired or wireless manner, the terminal device configured to display the recommended gaming machine information received from the gaming information providing device on the display device.

According to the above configuration, the terminal device transmits and receives the information to and from the gaming information providing device in the wired or wireless manner, and displays the recommended gaming machine information received from the gaming information providing device on the display device. Accordingly, in the terminal device, the customer can easily use the recommended gaming machine information provided from the gaming information providing device.

The invention is not limited to the above embodiments, but various changes can be made without departing from the scope of the claims. It is noted that an embodiment obtained by properly combining technical means disclosed in the above embodiments is also included in the technical scope of the invention.

One or more embodiments of the present invention can be used as a management device that provides gaming information to customers in an amusement hall such as a casino including slot machines and a pachinko parlor including pachinko machines.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

11 gaming information management server
12 terminal device
13 customer card
21 information acquisition and management unit (information acquisition unit and information management unit)
22 provided information producing unit
23 display language determination unit
24 display content determination unit
25 communication unit
31 kiosk terminal device
32 communication unit
33 controller
34 display device
35 Input device
36 storage device
37 card reader/writer
41 gaming machine
42 communication unit
43 customer management controller
44 customer management display device
45 Input device
46 storage device
47 card reader/writer
49 customer management unit
51 game operation unit
52 game controller
53 game display device
54 input amount processor
55 paid amount processor
56 input port
57 paying port
58 input device
71 mobile terminal device
72 communication unit
73 controller
74 display device
75 input device
76 storage device
77 card reader/writer

1. A gaming information providing device comprising:
an information acquisition unit that acquires gaming machine information, customer identification information, and preference information from a plurality of gaming machine,
wherein, in each of the game machines, a game medium is paid in or paid out from in a game,
wherein the gaming machine information comprises paying-out information indicating a paying-out status of the game medium in each of the gaming machines,
wherein the customer identification information identifies a plurality of customers who play the game with the plurality of gaming machines, and
wherein the preference information indicates a preference for the game of the gaming machine in each customer;
a storage device in which the pieces of information acquired by the information acquisition unit are stored;
an information management unit that classifies the plurality of customers into a plurality of customer types based on the preference information while classifying the plurality of gaming machines into a plurality of gaming machine types based on the gaming machine information; and
a provided information producing unit that produces recommended gaming machine information indicating a recommended gaming machine for each customer from the gaming machine type and the customer type.

2. The gaming information providing device according to claim 1, wherein the preference information is paying-in information indicating a paying-in status of the game medium for the gaming machine in each customer.

3. The gaming information providing device according to claim 1, further comprising:
a display language determination unit; and
a display content determination unit,
wherein the information management unit manages nationality information on the customer as customer individual information,
wherein the display language determination unit determines a display language of the recommended gaming machine information based on a customer's nationality indicated by the nationality information, and
wherein the display content determination unit puts the recommended gaming machine information into a state in which the recommended gaming machine information is translated into the display language determined by the display language determination unit.

4. The gaming information providing device according to claim 3,
wherein the display language determination unit comprises a nationality-dependent display language list indicating the display language in plural set based on the customer's nationality, and
wherein the display content determination unit puts the recommended gaming machine information into a state in which the recommended gaming machine information is translated into the plurality of display languages indicated by the nationality-dependent display language list.

5. The gaming information providing device according to claim 4,
wherein the nationality-dependent display language list is a nationality-dependent priority display language list that indicates priority order of the plurality of display languages set based on the customer's nationality, and
wherein the display content determination unit puts pieces of the recommended gaming machine information translated into the plurality of display languages into a state in which the pieces of recommended gaming machine information are arranged in a priority order indicated by the nationality-dependent priority display language list.

6. The gaming information providing device according to claim 5,
wherein the information acquisition unit acquires information indicating a previously-selected language,
wherein the previously-selected language is previously selected as the display language of the recommended gaming machine information by a terminal device that provides the recommended gaming machine information,
wherein the information indicating the previously-selected language is stored in the storage device, and
wherein the display content determination unit arranges the recommended gaming machine information in the previously-selected language at a top priority of the priority order when the previously-selected language is stored in the storage device.

7. A gaming information providing system comprising:
the gaming information providing device according to claim 1; and
a terminal device comprising a display device,
wherein the terminal device transmits and receives information to and from the gaming information providing device in a wired or wireless manner, and
wherein the terminal device displays the recommended gaming machine information received from the gaming information providing device on the display device.

8. A gaming information providing method comprising:
an information acquisition step of acquiring gaming machine information, customer identification information, and preference information from a plurality of gaming machines;
wherein, in each of the game machines, a game medium is paid in or paid out from in a game,
wherein the gaming machine information comprises paying-out information indicating a paying-out status of the game medium in each gaming machine,
wherein the customer identification information identifies a plurality of customers who play the game with the plurality of gaming machines,
wherein the preference information indicates a preference for the game of the gaming machine in each customer;
a storage step of storing the pieces of information acquired in the information acquisition step;
an information management step of classifying the plurality of customers into a plurality of customer types based on the preference information while classifying the plurality of gaming machines into a plurality of gaming machine types based on the gaming machine information; and
a provided information producing step of producing recommended gaming machine information indicating a recommended gaming machine for each customer from the gaming machine type and the customer type.

9. A program stored on non-transitory commuter medium that t cause a computer to perform:
an information acquisition step of acquiring gaming machine information, customer identification information, and preference information from a plurality of gaming machines;
wherein, in each of the game machines, a game medium is paid in or paid out from in a game,
wherein the gaming machine information comprises paying-out information indicating a paying-out status of the game medium in each gaming machine,
wherein the customer identification information identifies a plurality of customers who play the game with the plurality of gaming machines,
wherein the preference information indicates a preference for the game of the gaming machine in each customer;
a storage step of storing the pieces of information acquired in the information acquisition step;
an information management step of classifying the plurality of customers into a plurality of customer types based on the preference information while classifying the plurality of gaming machines into a plurality of gaming machine types based on the amine; machine information; and
a provided information producing step of producing recommended gaming machine information indicating a recommended gaming machine for each customer from the gaming machine type and the customer type.

10. (canceled)

11. The gaming program stored on a non-transitory computer-readable medium according to claim 9, wherein the preference information is paying-in information indicating a paying-in status of the game medium for the gaming machine in each customer.
